(19) United States
(12) Patent Application Publication
(10) Pub. No.: US 2011/0029587 A1
(43) Pub. Date: Feb. 3, 2011

(54) Updating Retrieval Codes In Response To File Transfers

(76) Inventor: John M. Fujii, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/935,583

(22) PCT Filed: Mar. 31, 2008
(86) PCT No.: PCT/US08/58924

§ 371 Date: Sep. 29, 2010

(51) Int. Cl. G06F 17/30; G06F 15/16

(52) U.S. Cl. 707/827; 707/E17.01; 707/E17.032

(57) ABSTRACT

A system comprises processing logic, a data structure that contains one or more retrieval codes, each retrieval code comprising a first portion and a second portion, and a network interface by which the system couples to other systems external to the system. The processing logic updates the first portion of a retrieval code in the data structure when the processing logic detects that a file corresponding to the retrieval code has been transferred between the other systems. The processing logic updates the second portion of the retrieval code in the data structure when the processing logic detects that the file has been transferred between locations within a single one of the other systems.

### BACKGROUND

Source data (e.g., JPEG photo files) can be used to generate physical artifacts (e.g., printed copies of the JPEG photo files). It is often desirable for someone who has a physical artifact to locate the original source data used to produce the physical artifact. However, due to various reasons including damage or loss to hardware storing the source data, relocation, archiving, or simply due to the increase in entropy with the passage of time, the source data of the physical artifact may be removed from its original location, thereby making it difficult for the holder of the physical artifact to locate the source data.

### BRIEF DESCRIPTION OF THE DRAWINGS

For a detailed description of exemplary embodiments of the invention, reference will now be made to the accompanying drawings in which:

FIG. 1 shows an illustrative network implementing techniques disclosed herein, in accordance with various embodiments;

FIG. 2 shows a detailed view of the system of FIG. 1, in accordance with various embodiments;

FIG. 3A shows a pair of timelines with illustrative changes in source data location information, in accordance with various embodiments;

FIG. 3B shows a data structure that corresponds to the timelines of FIG. 2A, in accordance with various embodiments;

FIG. 4 shows another illustrative network implementing the techniques disclosed herein, in accordance with various embodiments;

FIG. 5 shows a flow diagram of an illustrative method implementing the techniques disclosed herein, in accordance with various embodiments; and

FIG. 6 shows a conceptual illustration of the operation of another network implementing techniques disclosed herein, in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. “Networks” and “networking” correspond to systems of discretely partitioned, stored data. In some embodiments, “networks” include any form of organized and recallable data that may be indexed in hierarchical systems that are able to manage and abstract the data set as a single, collective point of reference.

“Source data” refers to any electronic data that is used to produce a tangible or non-tangible version, or “artifact,” of the source data. In some embodiments, source data is non-electronic. In some embodiments, artifacts are electronic while in other embodiments, artifacts are non-electronic. For example, a digital photo file may comprise source data, while a printout of that digital photo may comprise an artifact. In another example, an original paper document may comprise source data, and electronic or non-electronic copies of that original paper document may comprise artifacts. In still another example, a digital photo file may comprise source data, while electronic copies of that digital photo file may comprise artifacts.

The term “controller” may include electronic entities (e.g., computers, processing logic) as well as non-electronic entities (e.g., humans). The terms “code” and “location code” are interchangeable.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is a technique whereby a retrieval code uniquely associated with an artifact can be used to locate and recover the original source data used to produce that artifact. The technique is implemented on one or more networks comprising multiple network entities (e.g., computers). As source data that is originally stored on one computer is transferred to other computers, a manager computer on the network tracks the source data's location, naming identifiers, handling attributes, etc. and updates its records (referred to as “journal records”) accordingly. When the manager computer is queried regarding the location of the source data (using the retrieval code), the manager computer modifies the retrieval code to reflect the most current location of the source data. The modification may be derived from location information stored on the manager computer or another computer communicably coupled to the manager computer. The modified code is then used to request and obtain the source data. In this way, regardless of where or how frequently the source data is moved, computers that communicate with the central manager computer are able to locate and obtain source data.

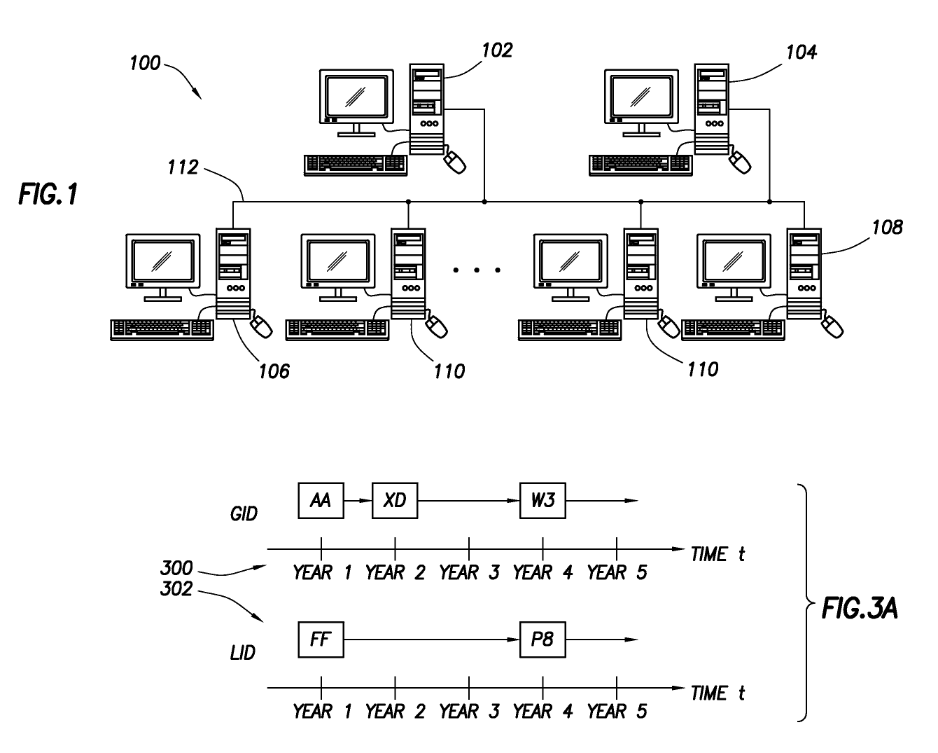

FIG. 1 shows an illustrative network 100 implementing the technique disclosed herein. The network 100 comprises a user interface computer 102, a manager computer 104, an original computer 106, a destination computer 108, and additional computer systems 110. The computers 102, 104, 106, 108 and 110 couple to each other via a network connection 112. The original computer 106 is adapted to store various types of source data, including photo files (e.g., JPEGs, BMPs, GIFs, etc.), video files (e.g., MPEG), audio files (e.g., MP3), and other types of source data of which copies can be made. The destination computer 108 is adapted to receive and store the source data from the original computer 106 via the connection 112. The manager computer 104 maintains records pertaining to the current and, optionally, the previous locations in which the source data is (or has been) stored. The user interface computer 102 enables a user to locate the source data on the network 100, regardless of the computer on which the data is stored (e.g., the destination computer 108). To locate the source data, the user interface computer uses a retrieval code associated with (e.g., printed or encoded upon) artifacts that have been generated using the source data.

For example, in operation, a digital photo may be taken using a digital camera. The digital photo may be subsequently transferred from the digital camera to the original computer 106. A printer (not specifically shown) coupled to the original computer 106 may be used to print a copy of the digital photo. The printer may encode a retrieval code on the printed photo (e.g., print on the reverse side of the printed photo, encode in a margin or watermark or otherwise electrically stamp the image with a readable code). The retrieval code is associated with the digital photo that is stored on the original computer 106. The code may be assigned by the manager computer 104, the original computer 102, or any other suitable entity on the network 100. In at least some embodiments, the code is unique on the network 100 such that no other code associated with any other source data on the network 100 is identical to the digital photo's retrieval code. The code may include numeric characters, alphabet characters, alphanumeric characters, one or more colors, bar codes, pictures, photos and non-printed codes such as sounds, textures, etc. Any identifier that uniquely identifies the source data with which it is associated on the network 100 may qualify as a retrieval code.

Over the next several years, the digital photo may be transferred (e.g., by humans, machines, etc.) to various other computers on the network 100 for any of a variety of reasons. For example, the digital photo may be transferred from the original computer 102 to multiple other computers 110 until it is finally transferred to and stored on the destination computer 108. Each of these intra-network transfers is monitored (e.g., automatically, without substantial human intervention or without human intervention at all) and recorded by the manager computer 104, as explained below. Even in cases where the digital photo is transferred from a computer on the network 100 to a computer on a different network and then back to a computer on the network 100, the manager computer 104 may still record the transfers that occur on the network 100, including the final destination of the digital photo. In some embodiments, the manager computer 104 records transfers that occur on networks that are peripheral to the network 100.

In any case, after several years have elapsed, the digital photo may be stored on the destination computer 108. Records on the manager computer 104 indicate that the digital photo is stored on the destination computer 108. At this time, a user may find the printed photo and enter the retrieval code from the printed photo into the user interface computer 102 via an application stored on the user interface computer 102. The user computer 102 uses the entered code to form a query signal that is subsequently transferred to the manager computer 104 via the network connection 112. In turn, the manager computer 104 compares the retrieval code in the query signal to records stored on the manager computer 104. If no match is found, the manager computer 104 returns an error notification signal to the user interface computer 102. If a match is found, the manager computer 104 returns the current location of the digital photo (e.g., the destination computer 108) to the user interface computer 102. In some cases, the process ends here, because the current location of the digital photo is sufficient for the user's purposes. However, in some cases, the user may wish to actually receive the digital photo. In such cases, the user interface computer 102 sends a request signal to the computer associated with the current location of the digital photo (e.g., the destination computer 108). In turn, the destination computer 108 provides the digital photo to the user interface computer 102 via the network connection 112. The operation of the computers on the network 100 is now described in detail in the context of the foregoing example.

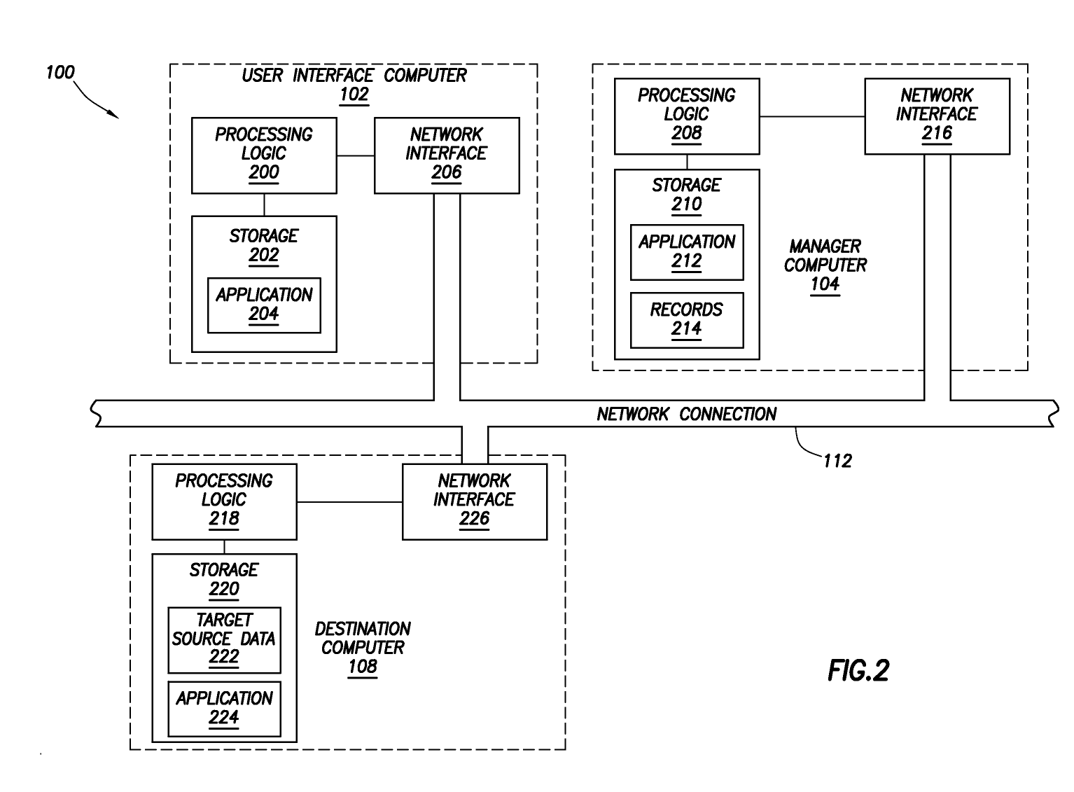

FIG. 2 shows a detailed version of the network 100 of FIG. 1. As previously described, the network 100 comprises the user interface computer 102, the manager computer 104 and the destination computer 108, all of which couple to each other via the network connection 112. The user interface computer 102 comprises processing logic 200 and storage 202 (e.g., random access memory (RAM)) that includes an application 204 executable by the processing logic 200, and a network interface 206. The network interface 206 enables the user interface computer 102 to send and receive data on the network connection 112.

The manager computer 104 comprises processing logic 208, storage 210 (e.g., RAM) that includes an application 212 executable by the processing logic 208 and records 214, and a network interface 216. The network interface 216 enables the manager computer 104 to send and receive data on the network connection 112.

The destination computer 108 comprises processing logic 218, storage 220 (e.g., RAM) that includes source data 222 and an application 224 executable by the processing logic 218, and a network interface 226. The network interface 226 enables the destination computer 108 to send and receive data on the network connection 112.

As previously described, a user of the user interface computer 102 may possess an artifact—such as a printout of a digital photo—that includes a retrieval code. In various embodiments, the artifact may be a tangible and physical item. In other embodiments, the artifact may be non-tangible (e.g., electronic, audio-only, visual-only, or audio/visual, including movies and television shows). The retrieval code is associated with the source data—such as the digital photo—that was used to produce the artifact. The retrieval code may include any of a variety of indicators that uniquely identifies the source data on the network 100. The application 204, when executed by processing logic 200, provides a graphical user interface (GUI) on a display (shown in FIG. 1) of the user interface computer 102. The GUI provides the user of the computer 102 an opportunity to input the code into the computer 102. The retrieval code may be input using any suitable apparatus, such as a keyboard, mouse or touchpad, touch-screen, voice-activated software, optical scanning, radio input, etc. In an illustrative embodiment, the retrieval code may comprise N portions, each of which facilitates the network's attempt to locate the target source data. For instance, the retrieval code may be
W3*P8
   The first portion of the retrieval code, W3, is separated from the second portion of the code, P8, by any suitable delimiting symbol(s) (e.g., an asterisk) so that computers on the network 100 are able to parse the code into its individual components. If more than one delimiter is used in a retrieval code, then at least one delimiter symbol should be unique and occur only once in the stream. Delimiters may be referred to as “pivots” and the unique, singular delimiter identifies the master pivot as a separator between two key search sets or domains.

The first portion of the retrieval code is indicative of the global location of the target source data and is thus unique on the network. Stated in another way, the first portion of the retrieval code is indicative of the computer or other entity, among all entities in the network 100, that possesses the target source data at the time the artifact is generated (e.g., printed). Thus, the first portion of the retrieval code is referred to as the Global Identifier (GID). While the present example and illustrations in the figures indicate that the entities on the network 100 are computers, the scope of this disclosure includes other types of entities that are able to store and index target source data. For example, if the target source data happens to be stored on a portable music device that cannot connect directly to the network 100, the owner of the portable music device may be registered as the global network entity possessing the target source data. In such embodiments, requests to obtain the target source data (described below) may include, for example, sending an email or making a phone call to the owner of the portable music device. Entities also may include organizations, such as libraries, businesses, etc., or even humans. Further, entities may include other searchable systems outside of the system currently being searched.

The second portion of the retrieval code is indicative of the specific location of the target source data within the entity possessing the target source data. For example, while the first portion of the retrieval code is indicative of the computer storing the target source data, the second portion of the retrieval code may be indicative of a journal record holding a local filename and path that specifies precisely where the target source data is stored in the computer. Thus, the second portion of the code is referred to as the Local Identifier (LID). In embodiments where there are N components in the code with N greater than 2, the components are separated from each other using any suitable delimiting pivot symbol(s) (e.g., multiple asterisks).

Upon receiving the retrieval code (e.g., from a user), the processing logic 200 causes the code to be transferred to the manager computer 104. The network address (e.g., Internet Protocol (IP) address) of the manager computer 104 may be stored in the storage 202. The journal records of manager computer 104 record transfers of source data from one entity in the network to another (e.g., between the manager computer 104 and a network entity other than the manager computer 104; between two or more network entities other than the manager computer 104, etc.) so that the manager computer 104 is always, or almost always, “aware” of the current location of all source data on the network 100. The manager computer 104 stores a data structure, referred to as journal records 214, that stores the current location and previous locations of each source datum. In some embodiments, the manager computer 104 and the user interface computer 102 may be the same computer. Multiple data structures may be used if multiple source data are being tracked.

The manager computer 104 receives the retrieval code from the user interface computer 102. When executed by the processing logic 208, the application 212 causes the processing logic 208 to parse the retrieval code into its respective components. The processing logic 208 parses the retrieval code using the delimiters (e.g., asterisks) used to separate the components. Thus, the processing logic 208 would parse the illustrative code above into its components W3 and P8. The processing logic 208 then compares the GID (e.g., W3) to the journal records 214 to locate a match. If no match is found and there are no other connected resources (e.g., computers) to inquire (e.g., other networks and/or managers), the processing logic 208 sends an error signal to the user interface computer 102, which may display an error message to the user of the computer 102. If no match is found but there are other resources coupled to the processing logic 208, the processing logic 208 may exchange signals with such resources to determine whether those resources store the target source data. If a match is found, the manager computer 104 sends a request signal to the network entity (associated with the GID) that possesses the target source data in order to obtain the target source data. Alternatively, if a match is found, the manager computer 104 sends a notification signal to the user interface computer 102 (and, thus to the user of the computer 102) that indicates where the target source data is available.

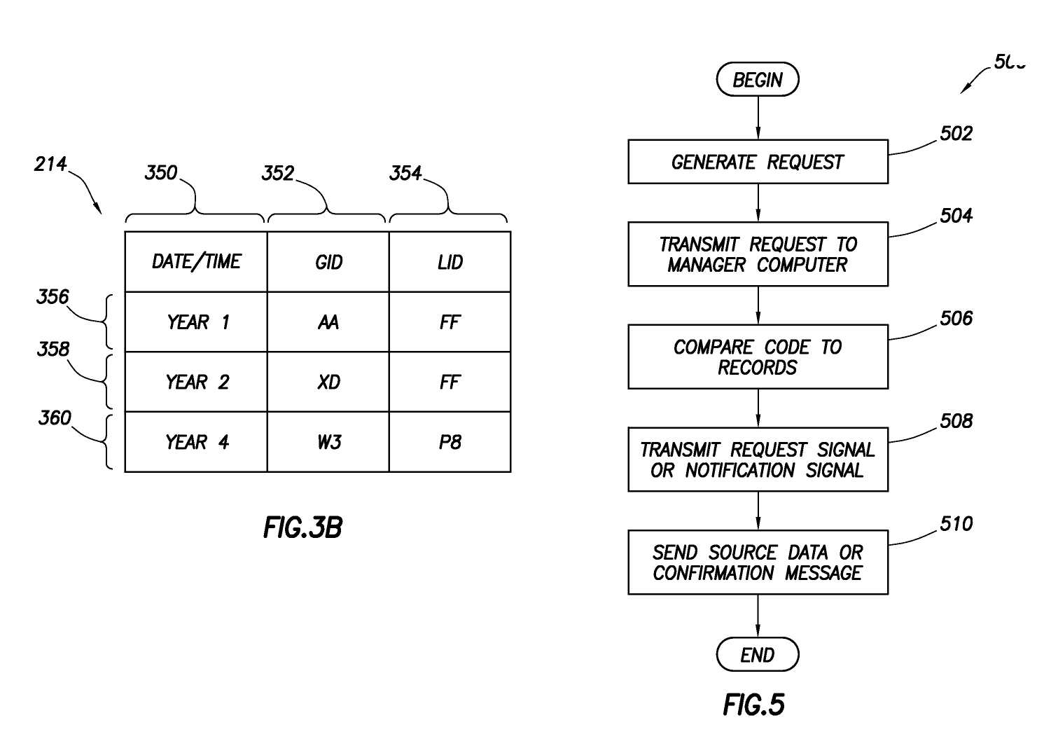

FIG. 3A shows illustrative timelines 300 and 302 of illustrative journal records. Timeline 300 is associated with the GID (e.g., W3) of the retrieval code and timeline 302 is associated with the LID (e.g., P8) of the retrieval code. Each of the timelines indicates retrieval code components associated with a target source datum at various times. For example, the timeline 300 indicates that in year 1, the GID of a retrieval code for a target source datum was AA. Timeline 302 indicates that in year 1, the LID of the code was FF. Timeline 300 indicates that in year 2, the GID of the retrieval code changed from AA to XD. This change is indicative of a transfer of the target source data from one computer to another computer entity in the network. The computer that formerly stored the source data (in year 1) was associated with the GID AA, while the computer that stored the source data in year 2 was associated with the GID XD. The timeline 300 further indicates that while the target source data was stored on the same network computer (the computer corresponding to GID XD) between years 2 and 3, in year 4, the target source data is transferred to another network computer associated with the GID W3. Similarly, the timeline 302 indicates that while the target source data maintained the same filename or path (indicated as FF) between years 1 and 3 despite being transferred between multiple computers, in year 4, the filename or path changed (indicated as P8). Thus, for example, while in year 1 the target source data was stored in the original computer 106 (FIG. 1) under a particular filename, by year 4, the target source data was stored in the destination computer 108 under a different filename.

As shown in FIG. 3B, the manager computer 104 records such transfers between computers and changes in filenames, paths, etc. in journal records 214. For example, when such transfers or changes occur, the network entity or entities involved in the transfer or change may notify (e.g., by transmitting one or more signals) the manager computer 104 accordingly. In turn, the manager computer 104 logs the transfer or change in journal records 214. In some embodiments, the transfer or change may involve the manager computer 104. In such cases, the manager computer 104 logs the transfer or change in journal records 214 as it would for any other network entity. Records 214 comprise a plurality of entries 356, 358 and 360. Each entry comprises multiple fields, including, a date/time stamp field 350, a GID field 352 and an LID field 354. Entry 356 indicates that in year 1, the location of the target source data corresponded to the code AA*FF, which indicates that the target source data was stored in a network entity (e.g., the original computer 106) corresponding to the GID AA and in a folder or file path corresponding to the LID FF. Entry 358 indicates that in year 2, the location of the target source data corresponded to the code XD*FF, which indicates that the target source data was stored in a network entity (e.g., another computer 110) corresponding to the GID XD and in a folder or file path corresponding to the LID FF. Entry 360 indicates that in year 4, the location of the target source data corresponded to the code W3*P8, which indicates that the target source data was stored in a network entity (e.g., the destination computer 108) corresponding to the GID W3 and in a folder or file path corresponding to the LID P8. Years 3 and 5 may optionally be omitted from the records 214 because no changes in code occurred during those years. The codes shown in the records 214 of FIG. 3B are illustrative.

The description of the GID and LID provided herein uses alphanumeric symbols. However, in some embodiments, the retrieval codes may comprise actual IP network addresses and explicit filenames or file paths. In some embodiments, when implemented, the codes comprise alphanumeric indicators as shown in FIG. 3B, but one or more of the computer systems on network 100 stores a translation table usable to translate the alphanumeric indicators to usable IP network addresses, file/path names, or other identifying information. In some embodiments, instead of translating from codes to IP network addresses and filenames or paths, each network entity may be store its GID so that it is able to receive communications addressed to that GID. Similarly, each network entity may store multiple LIDs corresponding to various source data stored thereupon, so that communications containing LIDs can be matched to the proper target source data. As previously mentioned, retrieval codes (including GIDs and/or LIDs) may include alphanumerics, colors, bar codes, textures, pictures, photos, sound clips, etc. Any and all such variations are encompassed within the scope of this disclosure. While the description herein assumes the retrieval codes include alphanumerics, in cases where colors are used, the user may manually enter the retrieval code color into the user interface computer (e.g., using a keyboard, mouse or scanning device). In cases where bar codes, textures, pictures or photos are used, a scanner coupled to the user interface computer may detect and store the code(s). In cases where the retrieval codes comprise sound clips, a microphone or other suitable capture device coupled to the user interface computer may be used to detect and store the code(s).

By comparing the retrieval code W3*P8 to the records 214, the manager computer 104 determines that the target source data is currently stored in the network entity corresponding to the code W3 (e.g., the destination computer 108), and further that within that network entity, the target source data is stored in a location journal record P8. In some cases, the retrieval code received by the manager computer 104 from the user interface computer 102 may be outdated. For example, the retrieval code received from the user interface computer 102 may be XD*FF or, alternatively, AA*FF. In such cases, when the manager computer 104 compares the outdated code to the records 214, the computer 104 determines that the code is outdated and replaces the outdated code with the most current code. Thus, if the received signal has the code XD*FF, the manager computer 104 determines that the code XD*FF has not been used since year 2, and that the current code for the target source data is W3*P8. Thus, the manager computer 104 sends a request signal or a notification signal (as described above) using the code W3*P8 instead of the code XD*FF.

Accordingly, the manager computer 104 may generate and transfer a request signal to the destination computer 108, requesting that the destination computer 108 provide the user interface computer 102 with the target source data. Alternatively, the manager computer 104 may generate and transfer a notification signal to the user interface computer 102 that indicates that the destination computer 108 possesses the target source data. In turn, the user interface computer 102 may generate and send a request signal to the destination computer 108, or may notify a user of the user interface computer 102 that the target source data is stored in the destination computer 108. All such variations are included within the scope of this disclosure.

If a request signal is sent to the destination computer 108, the application 224, when executed by the processing logic 218, causes the processing logic 218 to generate and transfer a copy of the target source data 222 to the requesting network entity (e.g., the user interface computer 102 and/or the manager computer 104).

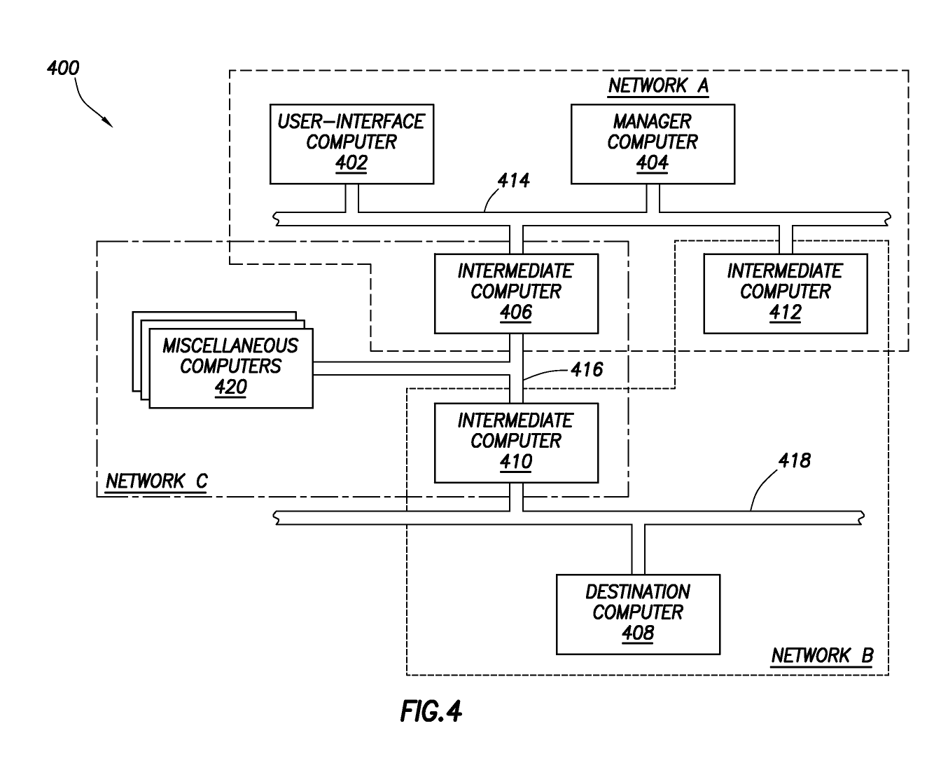

The network 100 described above includes the user interface computer 102, the manager computer 104, and the destination computer 108. However, in some embodiments, such computers/entities may be on different networks or management systems. For example, the user interface computer and the manager computer may be on a first network, while the destination computer may be on a second, different network. There may be multiple computers or network entities that are on both the first and second networks, thereby providing “gateways” through which the destination computer may be accessed by the manager computer and/or the user interface computer. For example, referring to FIG. 4, there is shown a system 400 that comprises networks A, B and C. Network A includes a user interface computer 402, a manager computer 404, an intermediate computer 406 and an intermediate computer 412, all coupled via a network connection 414. Network B includes the intermediate computer 412, an intermediate computer 410, and a destination computer 408, all coupled via a network connection 418. Network C includes intermediate computers 406 and 410, as well as miscellaneous computers 420, all coupled via a network connection 416. The system 400 operates in a manner similar to that of the network 100 previously described.

For example, the manager computer 404 receives a request from the user interface computer 402 for target source data. The manager computer 404 determines that the target source data is currently stored on the destination computer 408. However, as shown, there are multiple paths by which the manager computer 404 may access the destination computer 408. One path includes intermediate computers 406 and 410, while the other path includes only intermediate computer 412. The manager computer 404 determines which path is the most efficient path based on the number of entities the manager computer 404 knows to be residing on each path. Other factors also may be used, and the scope of this disclosure includes any and all such factors. For example, the manager computer 404 may query the computers 406, 410 and 412 to determine how many entities are presently functioning on each prospective path. Accordingly, in the present example, the manager computer 404 selects the path including intermediate computer 412 instead of the other path including the intermediate computers 406 and 410. The manager computer 404 then transfers the target source data request to the intermediate computer 412. Software running on the intermediate computer 412 causes the computer 412 to receive the request and to forward it to the destination computer 408. In systems more complex than the one shown in FIG. 4, the intermediate computer 412 (like the manager computer 404) may be required to select from multiple possible paths to the destination computer 408. In such cases, the intermediate computer 412 may select the best path in a manner similar to that of the manager computer 404.

Referring to FIGS. 1 and 4, in the embodiments described above, the manager computer uses its journal records (e.g., data structures) to determine both the current GID and the current LID. However, in some cases, one or both of these portions of the code may be inaccurate. In case the GID is inaccurate but the LID is accurate, the manager computer sends a request signal to the wrong destination computer. The destination computer compares the GID of the request signal to its own corresponding identification information (e.g., if the GID is associated with an IP address, the destination computer compares its IP address against the GID IP address) and determines that the request signal has erroneously been sent to that destination computer. As a result, the destination computer returns an error signal to the manager computer. In case both the GID and the LID are inaccurate, the same technique is implemented.

However, in case the GID is accurate but the LID is inaccurate, the proper destination computer receives the request signal, but the specific location of the target source data on that destination computer may be inaccurate. In such cases, the destination computer does not immediately return an error signal, but instead performs a search of its own system to locate the target source data. In some embodiments, the destination computer may perform a search for a filename or series of filenames that corresponds to that held by the journal record LID. In some embodiments, the destination computer may maintain one or more data structures that track the current location of the target source data or last known forwarding location for search. Other suitable measures also may be implemented. In any case, the destination computer attempts to locate the target source data by using its local records. If it is successful in locating the source data, the destination computer provides the source data or a confirmation signal to the requestor. If it is unsuccessful in locating the source data, the destination computer returns an error message to the requestor. If data has moved to another location and is recorded in the local record chain, it is possible that this information is returned to the requestor for further record updates.

Further, in some embodiments, an LID may be changed one or more times. In some such embodiments, data structures may record all such changes in LIDs. If a query signal containing an LID is received by a network entity, and if the LID does not match any current LIDs on that network entity, the entity may search the data structure to determine whether a match is found. If a match is found, the LID is outdated, and the network entity replaces the outdated LID with the most current LID. If no match is found, an error signal may be returned to the requestor.

FIG. 5 shows a flow diagram of an illustrative method 500 implemented in accordance with various embodiments. The method 500 comprises generating a request that comprises a retrieval code associated with the target source data (block 502). The request may be generated, for example, using a user interface computer or other suitable entity. The method 500 also comprises transferring the request to the manager computer (block 504). The method 500 then comprises comparing and updating the retrieval code associated with the request to records stored on the manager computer (block 506). The comparison may be performed by the manager computer or other suitable entity. The method 500 further comprises generating and transferring a request signal (to the network entity possessing the target source data) or a notification signal (to the user interface computer 102) comprising information indicative of the current location of the target source data (block 508). Alternatively, the current location of the target source data may be transferred to the user interface computer, which in turn transmits a request signal to the current location of the target source data. Each of these alternatives may be performed by the manager computer or other suitable entity. Once the entity that possesses the target source data receives the requek signal, that entity either transfers a copy of the source data to the requestor, confirms that it does have the source data and that it is available for pick-up (e.g., in the case of a brick-and-mortar library with a printed publication on its shelves) (block 510), or gives relay information for further inquiry follow-up (e.g., information indicating that the request record is out-of-date and the last known location of the source data).

At least some of the embodiments described above implement a manager computer 104 that acts as a global recordkeeper of all transfers, changes, etc. that occur on the network or networks with which the manager computer is associated. However, in some embodiments, a data structure (referred to as “history journal” or “history journal records”) may be used in lieu of the manager computer 104. A history journal comprises a data structure that accompanies the target source data to wherever the source data is transferred. The history journal records the location of each network entity on which the target source data is stored, as well as the location(s) at which the source data is stored within those network entities (e.g., including GID and LID information, IP addresses, paths or filenames, etc.). The history journal may include additional information, such as times, dates, etc. Any other suitable information also may be included.

Each time the target source data is transferred to a different location (e.g., a different network entity, a different location on the same network entity), a copy of the history journal is downloaded to that location. The copy of the history journal left at that location records the new location to which the target source data is transferred, so that inquiries regarding the target source data may be forwarded to the new location. In this way, a historical “chain” is formed that includes each of the network locations on which the target source data has been stored.

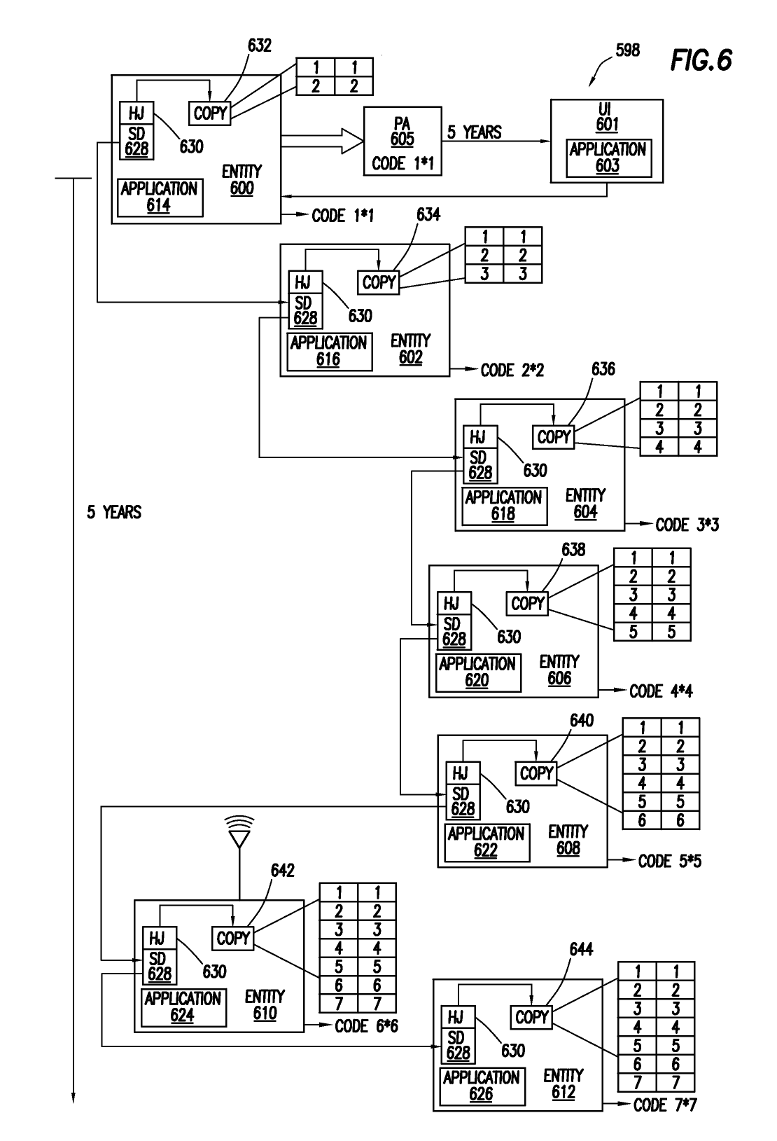

FIG. 6 shows a conceptual illustration of the historical links established using a history journal in lieu of a centralized manager computer. Specifically, FIG. 6 shows a network 598 comprising network entities 600, 602, 604, 606, 608, 610 and 612. The entities may comprise any electronic devices capable of sending and receiving information on the network. For example, the entities may comprise servers, personal computers, personal digital assistants, mobile phones, etc. In some embodiments, one or more of the entities may be non-electronic (e.g., humans) but may still be able to perform the functions of electronic entities as they are described below. The network 598 comprises an additional user-interface 601. At least some of the entities shown on the network 598, including the user interface 601, are communicably coupled. In at least some embodiments, the user interface 601 is communicably coupled to all other entities on the network 598.

Each entity shown on the network 598 comprises an application which, when executed, causes that entity to participate in the technique described below. In particular, to this end, entities 600, 601, 602, 604, 606, 608, 610 and 612 comprise applications 614, 603, 616, 618, 620, 622, 624 and 626, respectively. In operation, the entity 600 may comprise source data 628 that is used to produce a physical artifact 605. The source data 628 may comprise, for example, a digital photo and the physical artifact (PA) 605 may comprise, for instance, a printout of the digital photo. The entity 600 has an illustrative GID of 1 and stores the source data 628 in a location having an illustrative LID of 1. Thus, the location at which the source data 628 is stored is referenced by the code 1*1. Accordingly, when the entity 600 produces the PA 605, the entity 600 encodes the PA 605 with the code 1*1. The code may be encoded onto the PA 605 in any suitable manner, as previously described.

Over a subsequent period of time (e.g., 5 years), the source data 628 may be moved several times. For example, as shown, the source data 628 is transferred from the entity 600 to the entity 602. When the source data is transferred to the entity 602, the source data on the entity 600 is deleted. Also when the source data is transferred to the entity 602, the history journal records 630 associated with the source data 628 are updated to indicate that the source data 628 is being transferred to a network entity 602 that has a GID of 2 and, more specifically, to a location on that network entity 602 that has an LID of 2, thus creating a code of 2*2. Accordingly, the history journal records 630 are updated to indicate not only the code 1*1 (where the source data 628 was previously, stored), but also the code 2*2 (where the source data 628 is being transferred). The entity 600 is able to update the history journal records 630 in this way due, for example, to signals received from the entity 602 indicating the code 2*2. Other suitable techniques also may be used. Prior to transferring the source data 628 (and associated history journal records 630) to the entity 602, a copy 632 of the history journal records 630 is downloaded to the entity 600. This copy 632 may remain on the entity 600 indefinitely.

During the same 5-year time period, the source data 628 may be transferred to numerous other network entities. As shown in FIG. 6, the source data 628 is transferred to the entity 602, followed by the entity 604, then the entity 606 followed by the entity 608, the entity 610, and finally, at the end of the 5-year period, the source data 628 is stored on the entity 612. Before, during or after each one of these transfers, the history journal records 630 are updated such that it reflects not only the codes of entities on which the source data 628 has previously been stored, but the code of the location to which the source 628 is being transferred. Thus, for example, when the source data 628 is transferred to a location on the entity 604 (having a code 3*3), the history journal records 630 are updated to reflect the codes 1*1, 2*2 and 3*3. A copy 634 of the history journal records 630 is downloaded to the entity 602, and the source data and the history journal records 630 are subsequently erased from the entity 602 (after being transferred to the entity 604). Similarly, updated copies 636, 638, 640 and 642 of the history journal records 630 are generated and downloaded to the entities 604, 606, 608 and 610, respectively.

As previously mentioned, at the end of the illustrative 5-year period, the source data 628 and its associated history journal records 630 may be stored at a location 7*7 on entity 612, as shown. Also at the end of the illustrative 5-year period, a user who possesses the PA 605 may desire to locate the original source data 628 used to produce the PA 605. Accordingly, the user may access the user interface 601 and input the code (i.e., 1*1) encoded onto the PA 605. The application 603, when executed, causes the user interface 601 to search for the source data 628 at a location corresponding to the code 1*1. As previously explained, the location corresponding to code 1*1 is on the entity 600. Although the source data 628 no longer resides on the entity 600, the copy 632 of the history journal is still extant on the entity 600. Thus, the entity 600 sends a signal to the user interface 601 indicating that while the code 1*1 is no longer a valid location code for the source data 628, the code 2*2 is the most recent “forwarding address” known to the entity 600.

Accordingly, the user interface 601 may then access a location on the network 598 that corresponds to the code 2*2 (i.e., the entity 602). Just as with the entity 600, the entity 602 sends a signal to the user interface 601 indicating that while the code 2*2 is no longer a valid location code for the source data 628, the code 3*3 is the most recent forwarding address known to the entity 602. The same process may occur with entities 604, 606, 608 and 610. When the user interface 601 inquires of the entity 612 whether the entity 612 has the source data 628, the entity 612 sends a signal to the user interface 601 indicating that the entity 612 does have the source data 628. The entity 612 may then provide the user interface 601 with the source data 628 and its associated history journal records 630. A copy 644 of the history journal records 630 is maintained on the entity 612. If the actual source data 628 is sent to the user interface 601, the journal records 630 and copy 644 may be updated to reflect the location code of the user interface 601. Otherwise, the history journal records 630 and copy 644 are not so updated.

The above description assumes that, if an entity does not have the source data, that entity will respond to the user interface with a signal indicating that the entity lacks the source data and containing the most recent forwarding address known to the entity. In such embodiments, the user interface must repeatedly check each entity in the historical chain until it finds the entity that possesses the source data. However, in other embodiments, the user interface may inquire of the entity 600 as to whether the entity 600 has the source data 628. The entity 600 does not have the source data 628, but it “knows” that the last known forwarding address of the source data 628 is the code 2*2. Instead of sending the user interface 601 a signal with the code 2*2, the entity 600 may take upon itself the task of inquiring of the entity 602 whether the source data 628 is stored on the entity 602. Similarly, because the entity 602 does not have the source data 628, it may inquire of the entity 604; the entity 604 may inquire of the entity 606; the entity 606 inquires of the entity 608; the entity 608 inquires of the entity 610; and the entity 610 inquires of the entity 612. Because the entity 612 has the source data 628, the entity 612 may either transfer the source data 628 back through the historical chain (to entities 610, 608, 606, 604, 602, 600 and user interface 601, in that order), or may transfer the source data 628 directly to the user interface 601. The scope of this disclosure encompasses any and all such variations.

As previously explained, signals may be sent to network entities based on the GID of the target source data. In some cases, a GID may be outdated. For instance, a network entity may change its GID one or more times. Accordingly, in some embodiments, each network entity may store a data structure that contains both its current GID as well as previously-implemented GIDs that are no longer in use. Thus, when a signal having an unrecognized GID is received, the network entity may compare the unrecognized GID to the previously-implemented GIDs to determine whether there is a match. If there is a match, the outdated GID is replaced with the most current GID. If there is no match, an error signal is returned. Similar techniques may be used for LIDs. Such techniques may be implemented in one or more entities in historical-chain networks, such as that shown in FIG. 6, or in the manager computer of a global, centralized network, such as that shown in FIGS. 1, 2 and 4.

The techniques described above may be implemented in various types of embodiments, including those in which records are almost continuously maintained and data is regularly tracked, as well as those in which data and associated records lay dormant (or archived) for a period of time. In cases such as the latter, data and associated records may be reintroduced, reactivated and refreshed within the system as desired.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A system, comprising:
processing logic;
a data structure that contains one or more retrieval codes, each retrieval code comprising a first portion and a second portion; and
a network interface by which the system couples to other systems external to said system;
wherein the processing logic updates the first portion of a retrieval code in said data structure when the processing logic detects that a file corresponding to the retrieval code has been transferred between said other systems or between the system and one of the other systems;
wherein the processing logic updates the second portion of the retrieval code in said data structure when the processing logic detects that said file has been transferred between locations within said system or within a single one of said other systems.

2. The system of claim 1, wherein, in said system and said other systems, the retrieval code is unique to the file.

3. The system of claim 1, wherein, upon receiving a request signal that contains an outdated version of said retrieval code, the processing logic uses the data structure to return a response signal that contains a current version of said retrieval code.

4. The system of claim 1, wherein, upon receiving a request signal that contains either a current version of said retrieval code or an outdated version of said retrieval code, the processing logic uses said data structure to determine a location of said file, and wherein the processing logic either obtains said file from said location or provides the location of said file to an entity that generated the request signal.

5. The system of claim 4, wherein the processing logic indirectly obtains said file from said location via another system.

6. The system of claim 1, wherein said first portion of the retrieval code corresponds to a network Internet Protocol (IP) address.

7. The system of claim 1, wherein said second portion of the retrieval code corresponds to a path and filename.

8. The system of claim 1, wherein the processing logic updates the first portion of the retrieval code in said data structure when the processing logic detects that a target system on which the file resides has changed its identification code.

9. The system of claim 1, wherein the processing logic updates the second portion of the retrieval code in said data structure when the processing logic detects that a location on a target system at which the file resides has changed its identification code.

10. The system of claim 1, wherein the processing logic updates said retrieval code to produce modified retrieval code, and wherein said modified retrieval code is added to the data structure such that the modified retrieval code does not replace the retrieval code.

11. The system of claim 1, wherein the processing logic updates the first portion of the retrieval code to correspond to said system or said other system to which the file is transferred.

12. The system of claim 1, wherein the processing logic updates the second portion of the retrieval code to correspond to a new location to which the file is transferred.

13. A system, comprising:
a controller;
target source data; and
a data structure that stores a code associated with the system;
wherein, when the controller removes said target source data from the system and transfers the target source data to another system external to said system, the controller records another code associated with the another system to the data structure;
wherein the controller receives a request, containing said code, from a requestor for the target source data;
wherein, in response to said request, the controller uses the code to locate said another code in the data structure and provides said another code to the requestor.

14. The system of claim 13, wherein said code is encoded onto a tangible artifact that corresponds to the target source data.

15. The system of claim 13, wherein, in response to said request, the controller uses the code to locate said another code in the data structure; wherein the controller receives the target source data from the another system and provides the target source data to the requestor.

16. The system of claim 13, wherein the data structure stores codes previously associated with the system.

17. The system of claim 16, wherein, upon receiving a request signal that contains one of said codes previously associated with the system, the controller responds to the request signal with a response signal that replaces the one of said codes previously associated with the system using said code.

18. The system of claim 13, wherein the system comprises an apparatus selected from the group consisting of a personal computer, a server, a personal digital assistant and a mobile phone.

19. A method, comprising:
when transferring target source data from a first network entity to a second network entity, copying a data structure associated with the target source data to the first network entity, the data structure includes codes associated with the first and second network entities;
transferring the target source data to the second network entity;
providing a request for the target source data from a requestor to the first network entity, the request comprising the code associated with the first network entity; and
in response to said request, the first network entity using the data structure stored on the first network entity to determine said code of the second network entity, the first network entity provides the requestor with the code for the second network entity.

20. The method of claim 19, further comprising:
when transferring the target source data from the second network entity to a third network entity, copying the data structure associated with the target source data to the second network entity, the data structure includes codes associated with the first, second and third network entities;
in response to transferring the code for the second network entity from the first network entity to the requestor, the requestor providing another request for the target source data to the second network entity, the another request comprising the code associated with the second network entity;
in response to said another request, the second network entity using the data structure stored on the second network entity to determine said code of the third network entity, the second network entity provides the requestor with the code for the third network entity;
in response to providing the requestor with the code for the third network entity, the requestor requesting and receiving the target source data from the third network entity.
